(19) United States
(12) Patent Application Publication
(10) Pub. No.: US 2007/0057981 A1
(43) Pub. Date: Mar. 15, 2007

(54) Method and apparatus to execute a spitting service on a wide array print head of an image forming apparatus

(75) Inventors: Jung-hwa Lee, Suwon-si (KR); Jung-hwan Kim, Seoul (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/496,579

(22) Filed: Aug. 1, 2006

(30) Foreign Application Priority Data
Sep. 9, 2005 (KR) 2005-84242

(51) Int. Cl. B41J 2/195

(52) U.S. Cl. 347/7

(57) ABSTRACT

A method and apparatus to perform a spitting service on a wide array print head includes detecting dot counts of print heads after a predetermined page is printed, determining spitting service levels corresponding to the detected dot counts, and executing spitting services for the print heads according to the spitting service levels. Accordingly, spitting services of a plurality of print heads of the wide array print head can be classified into several levels for execution, so that the print heads can maintain an optimum condition and provide a best printing quality, and unnecessary ink consumption can be reduced.

### CROSS-REFERENCE TO RELATED APPLICATIONS

This application claims priority under 35 U.S.C. §119(a) from Korean Patent Application No. 10-2005-0084242, filed on Sep. 9, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to a method and apparatus to execute a spitting service on a print head of an image forming apparatus having a wide array print head.

2. Description of the Related Art

A print head is serviced by wiping its nozzles to allow optimum printing, or by extracting ink to prevent the nozzles from being dried.

There are three major types of service methods used.

The first type of the service method is a method of collectively executing a service when a dot count for each color reaches a predetermined number. In this method, the service is executed regardless of whether printing is in progress or complete. Thus, if the service is executed in the middle of printing, nozzle performance may be different before and after the service, thereby affecting image quality.

The second type of the service method is a method of executing the service when the dot count reaches a predetermined number and after a page is printed. This method has a disadvantage in that a proper service may not be provided when needed in the middle of printing.

The third type of the service method is a method of collectively executing the service after each page is printed, regardless of the dot count. In this method, the service is unconditionally executed after each page, so even though the service is executed conveniently, ink consumption may increase due to an unnecessary service.

Recent demand for high speed printing has prompted the development of a wide array print head, in which a plurality of print heads are arranged across a width of a printing medium. The wide array print head can provide higher speed printing than a conventional shuttle type head in which the head reciprocates across the width of the printing medium.

However, nozzles of the wide array printing head often have widely varying ink consumption depending on nozzle position. Ink can easily dry on a nozzle which is rarely used. If the ink on the nozzle is dried, an ink extraction condition changes due to a change in ink density, thereby deteriorating image quality. In addition, if the ink dries too much, an extraction error may occur.

### SUMMARY OF THE INVENTION

The present general inventive concept provides a method and apparatus to perform a spitting service on a wide array print head according to a plurality of levels corresponding to a plurality of print heads.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a spitting service method of a wide array print head, the method including detecting dot counts of print heads after a predetermined page is printed, determining spitting service levels corresponding to the detected dot counts, and executing spitting services for the print heads according to the spitting service levels.

The foregoing and/or other aspect of the present general inventive concept may also be achieved by providing a computer-readable medium having embodied thereon a computer-readable program to execute a wide array print head spitting service method, the method including detecting dot counts of print heads after a predetermined page is printed, determining spitting service levels corresponding to the respective detected dot counts, and executing spitting services of the respective print heads according to corresponding ones of the spitting service levels.

The foregoing and/or other aspect of the present general inventive concept may also be achieved by providing a spitting service method of a wide array print head, the method including detecting temperatures of print heads after a predetermined page is printed, determining spitting service levels corresponding to the detected temperatures, and executing spitting services for the print heads according to the spitting service levels.

The foregoing and/or other aspect of the present general inventive concept may also be achieved by providing a computer-readable medium having embodied thereon a computer program to execute a wide array print head spitting service method, the method including detecting temperatures of print heads after a predetermined page is printed, determining spitting service levels corresponding to the respective detected temperatures, and executing spitting services on the respective print heads according to corresponding ones of the determined spitting service levels.

The foregoing and/or other aspect of the present general inventive concept may also be achieved by providing a spitting service apparatus usable with a wide array print head including a dot count detection unit which detects dot counts of print heads after a predetermined page is printed, a service level determination unit which determines spitting service levels corresponding to the detected dot counts, and a service execution unit which executes spitting services for the print heads according to the spitting service levels.

The foregoing and/or other aspect of the present general inventive concept may also be achieved by providing a spitting service apparatus usable with a wide array print head including a temperature detection unit which detects temperatures of print heads after a predetermined page is printed, a service level determination unit which determines spitting service levels corresponding to the detected temperatures, and a service execution unit which executes spitting services for the print heads according to the spitting service levels.

The foregoing and/or other aspect of the present general inventive concept may also be achieved by providing a spitting service method of a wide array print head, the method including detecting dot counts of a plurality of driving elements provided in print heads after a predetermined page is printed, determining spitting service levels corresponding to the detected dot counts, executing spitting services for the print heads according to corresponding ones of the spitting service levels, initializing the detected dot counts, and checking an existence of a next page to be printed, wherein, if a page to be printed exists, the dot counts of the plurality of driving elements are detected.

The foregoing and/or other aspect of the present general inventive concept may also be achieved by providing a spitting service device for a wide array print head including a dot count detection unit which detects dot counts of a plurality of print heads after a page is printed, a service level determination unit which determines spitting service levels corresponding to the detected dot counts, a service execution unit which executes spitting services on the print heads according to corresponding ones of the spitting service levels, a dot count initialization unit which initializes the detected dot counts, and a next print check unit which checks an existence of a next page to be printed.

The foregoing and/or other aspect of the present general inventive concept may also be achieved by providing a spitting service device usable with an array print head including a detection unit to detect information on an ink consumption of respective print heads, a determination unit to determine spitting service levels corresponding to the respective information, and an execution unit to execute spitting services on the respective print heads according to corresponding ones of the spitting service levels.

The foregoing and/or other aspect of the present general inventive concept may also be achieved by providing a spitting service method usable in an array print head, the method including detecting information on ink consumption of respective print heads, determining spitting service levels corresponding to the respective information, and executing spitting services for the respective print heads according to corresponding ones of the spitting service levels.

The foregoing and/or other aspect of the present general inventive concept may also be achieved by providing a computer-readable medium having embodied thereon a computer program to execute a wide array print head spitting service method, the method including detecting information on ink consumption of respective print heads, determining spitting service levels corresponding to the respective information, and executing spitting services for the respective print heads according to corresponding ones of the spitting service levels.

The foregoing and/or other aspect of the present general inventive concept may also be achieved by providing a spitting service device including a detection unit to detect ink consumption information on a respective group of nozzles, a determination unit to determined spitting service levels corresponding to the respective information, and an execution unit to execute spitting services on the respective groups of nozzles according to corresponding ones of the spitting service levels.

The foregoing and/or other aspect of the present general inventive concept may also be achieved by providing an image forming apparatus including an array print head unit having a plurality of print heads arranged in a direction to form an image on a printing medium, a spitting service device usable with the array print head unit including a detection unit to detect information on an ink consumption of respective print heads, a determination unit to determine spitting service levels corresponding to the respective information, and an execution unit to execute spitting services on the respective print heads according to corresponding ones of the spitting service levels.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart illustrating a spitting service method of a wide array print head according to an embodiment of the present general inventive concept;

FIG. 2 is a view illustrating an image printing process of printing an image using the wide array print head;

FIG. 3 is a histogram illustrating an amount of ink used in each print head to print the image of FIG. 2;

FIG. 4 is a histogram illustrating the number of spitting services corresponding to ink usage of FIG. 3;

FIG. 5 is a view illustrating the ink usage and the number of spitting services according to levels;

FIG. 6 is a flowchart illustrating a spitting service method of a wide array print head in an image forming apparatus according to an embodiment of the present general inventive concept;

FIG. 7 is a block diagram illustrating a spitting service apparatus of a wide array print head in an image forming apparatus according to an embodiment of the present general inventive concept;

FIG. 8 is a block diagram illustrating a spitting service apparatus of a wide array print head in an image forming apparatus according to an embodiment of the present general inventive concept;

FIG. 9 is a flowchart illustrating a spitting service method in a spitting service apparatus of a wide array print head in an image forming apparatus according to an embodiment of the present general inventive concept;

FIG. 10 is a block diagram illustrating a spitting service apparatus of a wide array print head in an image forming apparatus according to an embodiment of the present general inventive concept;

FIG. 11 is a plan view illustrating the wide array print head of FIG. 2; and

FIG. 12 is a cross-sectional view illustrating one of a plurality of nozzles of the wide array print head of FIG. 11.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

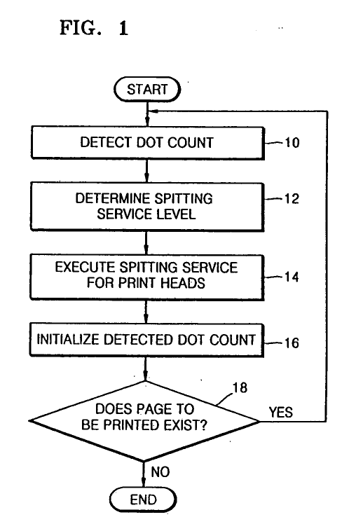

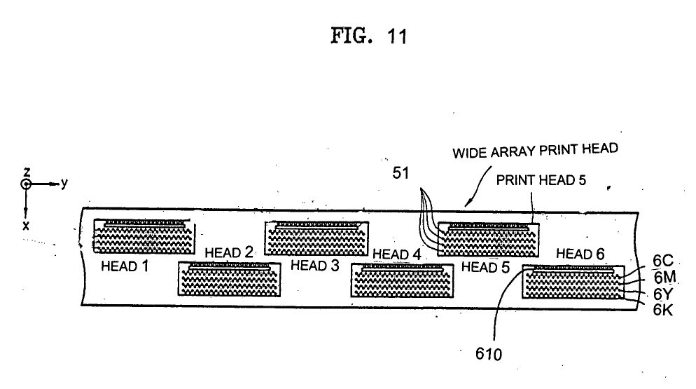

FIG. 1 is a flowchart illustrating a spitting service method of a wide array print head in an image forming apparatus according to an embodiment of the present general inventive concept. In the wide array print head of the image forming apparatus, a plurality of print heads are arranged in a longitudinal direction thereof. Each of the plurality of print heads includes a plurality of nozzles. The arrangement of the nozzles and the print heads on the wide array print head is illustrated in FIG. 11 as an example.

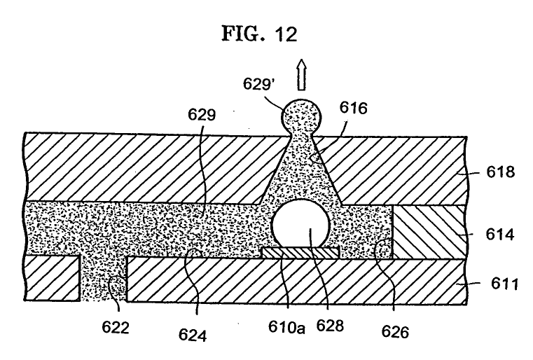

FIG. 11 is a plan view of the wide array print head of an inkjet image forming apparatus. FIG. 12 is a cross-sectional view illustrating one of a plurality of nozzles of the wide array print head of FIG. 11. Referring to FIG. 11, the print head 5 is installed in a direction Y with respect to a printing medium which is conveyed in a direction X. The print head 5 uses heat energy or a piezoelectric element as an ink firing source or a portion of a driving element, and is fabricated to have a high resolution through a semiconductor manufacturing process such as etching, depositing, and sputtering.

According to an embodiment of the present general inventive concept, a plurality of print heads (e.g. HEAD6), each may have a plurality of nozzle lines 6C, 6M, 6Y, and 6K may be formed on the print head 6. A driving element (driving circuit or driving source) 610 is included in the each of the plurality of print heads to selectively drive respective nozzles 51 or selectively drive groups of nozzles 51. Each nozzle formed on the print head 6 is connected to the driving element 610 through which a driving signal, power to eject ink, and image data are transmitted by a control unit (not shown). The arrangement of each nozzle on the print head 6 is illustrated in FIG. 12.

Referring to FIG. 12, the print head 6 with the above structure forms an image by ejection of ink supplied by an ink supplying device which will be described later, with use of the nozzles to eject the ink onto a printing medium. For a quick understanding of the example, the structure of the print head 6 and an operation of the ejection of ink droplets will be briefly described. In general, a print head may be categorized mainly into two types according to an ink droplet ejection mechanism as a portion of a driving element to eject the ink droplets. One is a thermal type print head that ejects ink droplets due to an expansion force of bubbles generated in ink by a heating source, and another is a piezoelectric type print head that includes a piezoelectric element and ejects ink droplets by pressure applied to ink due to a change of the piezoelectric element. Hereinafter, by way of explanation, a thermal type print head will be described as an example.

The ink droplet ejecting mechanism of the thermal type print head will be described in detail below. When a pulse current flows through a heater formed of a heating element, the heater instantaneously applies heat to the ink to boil the ink and generate bubbles therein, and the generated bubbles expand and apply pressure to the ink contained in a chamber. Consequently, ink around the nozzle is spitted or ejects from the nozzle in a droplet form.

FIG. 12 is a cross-sectional view illustrating the ejection of an ink droplet from the print head 6 illustrated FIG. 11. Referring to FIGS. 11 and 12, the print head 6 includes a substrate 611, barrier ribs 614 to define an ink chamber 626 which is filled with ink 629 and mounted on the substrate 611, a heater 610a installed in the ink chamber 626, and a nozzle plate 618 on which a nozzle 616 to eject an ink droplet 629′ is formed. The heater 610a of FIG. 12 and the driving element 610 of FIG. 11 may be called a driving element or a driver. When a pulse current is applied to the heater 610a to generate heat, ink 629 filling the ink chamber 626 is heated to generate bubbles. The generated bubbles continuously expand, and accordingly, pressure is applied to the ink 629 filling the ink chamber 626 to eject the ink droplet 629′ through the nozzle 616. Then, the ink 629 is provided from an ink containing unit to an inside of the ink chamber 626 by a supplying device through a manifold 622 and an ink channel 624. Surface tension of the nozzle 626 and negative pressure thereof are balanced with each other so that the ink 629 remains inside the ink chamber 626. At this moment, if air bubbles are included in the ink flowing into the ink chamber 626, the air bubbles can affect a generation of bubbles 628 by the heater 610a. Moreover, the air bubbles in the ink can cause an ejection failure, thereby deteriorating printing quality. Therefore, when the ink is supplied to the ink chamber 626, the air bubbles are desirably removed from the ink.

Referring to FIG. 1, after a predetermined page is printed, dot counts of the respective print heads are detected (operation 10).

The spitting service method of the wide array print head of the present embodiment is executed after one page of printing is completed.

The dot counts of ink extracted from the respective print heads in the wide array print head are detected. Spitting service levels are determined according to the respective dot counts (operation 12). Spitting services are executed on the respective print heads according to the levels (operation 14). The dot counts are initialized (operation 16), and it is determined whether a next page to be printed exists (operation 18).

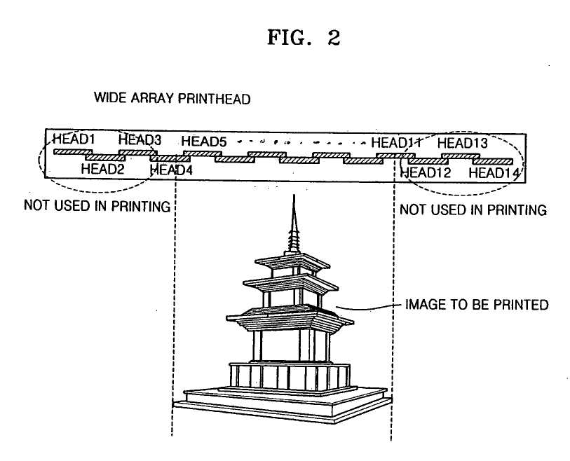

FIG. 2 is a view illustrating an image printing process of printing an image using the wide array print head. Referring to FIG. 2, a plurality of print heads (HEAD1, HEAD2, HEAD3, HEAD4, HEAD5 . . . HEAD11, HEAD12, HEAD13, HEAD14) which are provided in the wide array print head. The dot counts of the ink extracted from the respective print heads (HEAD1, HEAD2, HEAD3, HEAD4, HEAD5 . . . HEAD11, HEAD12, HEAD13, HEAD14) are detected.

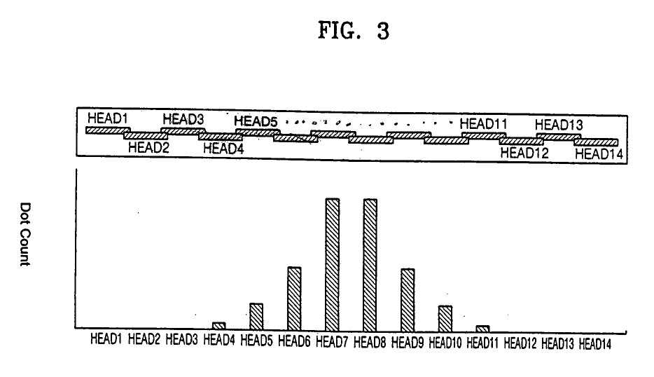

FIG. 3 is a histogram illustrating the amount of ink used in each print head to print the image of FIG. 2. The dot counts of the print heads at a center of the wide array print head are larger than the dot counts of the print heads located at left and right sides thereof according to the image of FIG. 2.

In particular, the dot counts of colors may be respectively detected for the print heads of the wide array print head. A plurality of color inks are respectively provided for the print heads. For example, if the print heads have color inks of cyan, magenta, yellow, and black, respectively, the dot counts of the color inks are respectively detected according to the image of FIG. 2.

Referring back to FIG. 1, after the operation 10, spitting service levels corresponding to the detected dot counts are determined (operation 12). The spitting service is a service operation of extracting an ink, irrespective of image printing, in order to prevent image quality deterioration caused by ink drying on nozzles of the print head.

The spitting service may be classified into several levels. The number of spitting is in inverse proportion to the dot counts of the extracted inks.

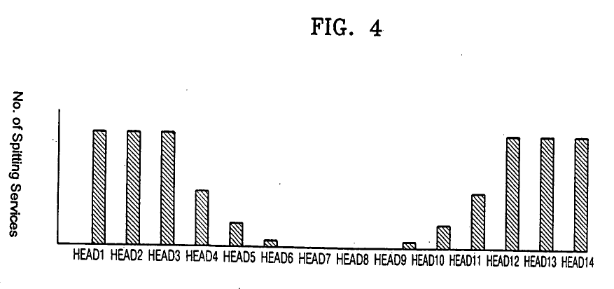

FIG. 4 is a histogram illustrating the number of spitting services corresponding to the ink usage of FIG. 3. Referring to FIG. 4, the number of executions of the spitting service is in inverse proportion to the dot counts of the extracted ink.

FIG. 5 is a view illustrating the ink usage and the number of spitting services according to levels (1, 2, . . . N). In a case of level 1 the dot count is small, and the number of corresponding spitting services is large. Since a small dot count represents that the ink is rarely extracted, the possibility of having dry ink in the nozzles of the print heads is high. Thus, in order to prevent the dry ink, the number of spitting services needs to be high.

In addition, in a case of level N, the dot count is large, and the number of corresponding spitting services is small. Since a large dot count represents that the ink is frequently extracted, a possibility of having dry ink in the nozzles of the print heads is relatively low. Thus, the number of spitting services does not need to be high.

In particular, the spitting service levels are determined using a table having information of the number of spitting which is in inverse proportion to the dot count.

The following tables 1 to 4 are examples of tables having information of the number of spitting which is in inverse proportion to the dot count of each color.

TABLE 1

| Cyan | Dot Count | Spitting |
|---|---|---|
| Level 1 | <50,000 | 2,000/noz. |
| Level 2 | <200,000 | 1,000/noz. |
| Level 3 | <800,000 | 800/noz. |
| Level 4 | <1,000,000 | 500/noz. |
| Level 5 | <5,000,000 | 150/noz. |
| Level 6 | <20,000,000 | 50/noz. |
| Level 7 | >20,000,000 | No Service |

TABLE 2

| Magenta | Dot Count | Spitting |
|---|---|---|
| Level 1 | <100,000 | 2,000/noz. |
| Level 2 | <400,000 | 1,000/noz. |
| Level 3 | <1,000,000 | 800/noz. |
| Level 4 | <3,000,000 | 500/noz. |
| Level 5 | <7,000,000 | 150/noz. |
| Level 6 | <25,000,000 | 50/noz. |
| Level 7 | >25,000,000 | No Service |

TABLE 3

| Yellow | Dot Count | Spitting |
|---|---|---|
| Level 1 | <100,000 | 2,000/noz. |
| Level 2 | <400,000 | 1,000/noz. |
| Level 3 | <800,000 | 800/noz. |
| Level 4 | <1,000,000 | 500/noz. |
| Level 5 | <2,000,000 | 150/noz. |
| Level 6 | <10,000,000 | 50/noz. |
| Level 7 | >10,000,000 | No Service |

TABLE 4

| Black | Dot Count | Spitting |
|---|---|---|
| Level 1 | <120,000 | 2,000/noz. |
| Level 2 | <500,000 | 1,000/noz. |
| Level 3 | <1,000,000 | 800/noz. |
| Level 4 | <2,000,000 | 500/noz. |
| Level 5 | <7,000,000 | 150/noz. |
| Level 6 | <15,000,000 | 50/noz. |
| Level 7 | >15,000,000 | No Service |

Here, “/noz.” indicates ‘per nozzle of a print head.’ Tables 1 to 4 illustrate that spitting service frequencies are in inverse proportion to the dot counts, and may be classified into several levels for each of the cyan, magenta, yellow, and black inks.

The spitting service levels corresponding to the dot counts detected in the operation of FIG. 1 are determined for each color of the print heads with reference to tables 1 to 4.

For example, with respect to a print head 5 (for example, HEAD5) of FIGS. 2 to 5, if a cyan dot count is “70,000,” a magenta dot count is “70,000,” a yellow dot count is “1,100,000,” and a black dot count is “16,000,000,” then the spitting service level for a nozzle extracting cyan ink of the print head 5 is determined to be a level 2 with reference to table 1, the spitting service level for a nozzle extracting magenta ink of the print head 5 is determined to be a level 1 with reference to table 2, the spitting service level for a nozzle extracting yellow ink of the print head 5 is determined to be a level 5 with reference to table 3, and the spitting service level for a nozzle extracting black ink of the print head 5 is determined to be a level 7 with reference to table 4. Here, referring to FIG. 11, the print head 5 (HEAD5) may have a plurality of nozzle lines 51 each having a plurality of nozzles to eject one of the cyan ink, the magenta ink, the yellow ink, and the black ink, for example. As illustrated by HEAD6, each print head of the wide array print head may have a plurality of nozzles in a plurality of nozzle lines grouped according to color of ink (6C, 6M, 6Y, 6K). In this case, the nozzles of the respective nozzle lines 51 are subject to the execution of the spitting service according to the above levels corresponding to the ink color and the dot count. The detailed structure of the individual nozzles will be discussed later with respect to FIG. 12.

If the print head 5 ejects only a single color ink, the spitting service on the print head 5 can be performed according to levels determined using one of the Tables 1-4.

After the operation 12, spitting services for respective print heads are executed based on the assigned spitting service levels (operation 14 of FIG. 1).

In the above example, the spitting service for the nozzle extracting the cyan ink of the print head 5 executes the spitting “1,000” times based on the level 2, the spitting service for the nozzle extracting the magenta ink of the print head 5 executes the spitting “2,000” times based on the level 1, the spitting service for the nozzle extracting the yellow ink of the print head 5 executes the spitting “150” times based on the level 5, and the spitting service for the nozzle extracting the black ink of the print head 5 does not execute any spitting based on the level 7.

After the operation 14, the detected dot counts are initialized (operation 16 of FIG. 1). The dot counts are reset to zero, for example.

After executing all of the spitting services for the wide array print head, the detected dot counts are initialized. In order to record new dot counts as a next page is printed, currently recorded dot counts are initialized.

After the operation 16, the existence of a new page to be printed is checked (operation 18).

If the page to be printed exists, each operation described above is repeated, and if no page to be printed exists, spitting service is complete.

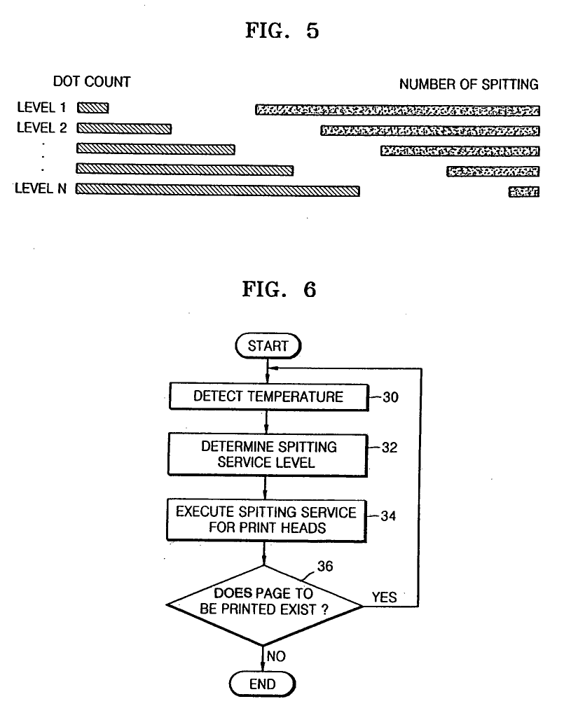

FIG. 6 is a flowchart illustrating a spitting service method of a wide array print head according to an embodiment of the present general inventive concept.

First, after a predetermined number of pages are printed, temperatures of print heads are detected (operation 30). Here, the predetermined number of pages may be one page.

The spitting service of the wide array print head of the present general inventive concept may be executed after one page of printing.

The temperatures of the respective print heads in the wide array print head are detected. The temperatures of the respective print heads are in proportion to dot counts. As the dot counts increase, the temperatures increase since the print heads are used more frequently, and as the dot counts decrease, the temperatures decrease since the print heads are used less frequently.

After the operation 30, the spitting service levels corresponding to the detected temperatures are determined (operation 32).

The spitting service may be classified into several levels. The number of spitting is in inverse proportion to the temperature of the print head.

Since a low temperature represents that the ink is rarely extracted, a possibility of having dry ink in the nozzles of the print heads is high. Thus, in order to prevent the dry ink, the number of spitting services needs to be high.

In addition, since a high temperature represents that the ink is frequently extracted, the possibility of having dry ink in the nozzles of the print heads is relatively low. Thus, the number of spitting services does not need to be high.

The spitting service levels are determined using a table having information of the number of spitting services, which is in inverse proportion to the temperature of the print heads. The table is similar to tables 1 to 4, for example.

After the operation 32, the spitting services for the respective print heads are executed according to the corresponding spitting service levels (operation 34). The execution of the spitting services is similar to aforementioned operation 14, so a detailed description will be omitted.

After the operation 34, an existence of a new page to be printed is checked (operation 36).

If a page to be printed exists, each operation described above is performed or repeated, and if no page to be printed exists, the spitting service is complete.

The embodiments of the present general inventive concept can be written as computer code/instructions/programs and can be implemented in general-use digital computers that execute the programs using a computer readable recording medium. Examples of the computer readable recording medium include magnetic storage media (e.g. ROM, floppy disks, hard disks, etc.), optical recording media (e.g. CD-ROMs, or DVDs), and storage media such as carrier waves (e.g. transmission through the Internet).

In addition, the computer readable recording medium can also be distributed over network coupled computer systems so that the computer readable code is stored and executed in a distributed fashion. Also, functional programs, code, and code segments for accomplishing the present general inventive concept can be easily construed by programmers skilled in the art to which the present general inventive concept pertains.

A spitting service apparatus of a wide array print head of the present general inventive concept will now be described with reference to the accompanying drawings.

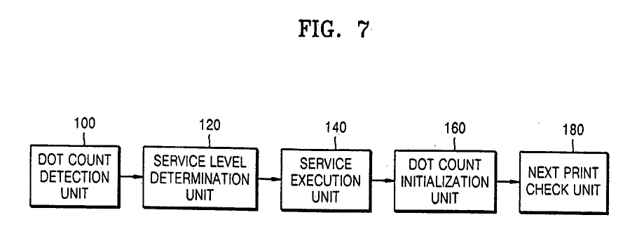

FIG. 7 is a block diagram illustrating a spitting service apparatus of a wide array print head according to an embodiment of the present general inventive concept. The spitting service apparatus includes a dot count detection unit 100, a service level determination unit 120, a service execution unit 140, a dot count initialization unit 160, and a next print check unit 180.

After a predetermined number of pages are printed or one or more number of pages are printed, the dot count detection unit 100 detects dot counts of print heads and outputs a detection result to the service level determination unit 120.

When the predetermined number of pages is one page, the spitting service of the wide array print head of the present general inventive concept may be executed after one page of printing.

The dot count detection unit 100 detects the dot counts of ink extracted from the respective print heads provided in the wide array print head.

In particular, the dot count detection unit 100 detects the dot counts of colors provided in the print heads of the wide array print head.

A plurality of ink colors may be provided in the print heads. For example, if the print heads have cyan, magenta, yellow, and black inks, the dot count detection unit 100 detects the dot counts of the cyan, magenta, yellow, and black inks.

The service level determination unit 120 determines a spitting service level corresponding to the detected dot count and outputs a detection result (the spitting service level) to the service execution unit 140.

The spitting service may be classified into several levels. The number of spitting services is in inverse proportion to the temperature of the print head.

The service level determination unit 120 determines the spitting service levels using a table having information of the number of spitting which is in inverse proportion to the dot count.

Tables 1 to 4 are examples of the table having information of the number of spitting services which is in inverse proportion to the dot count of each color.

The service level determination unit 120 determines the spitting service levels corresponding to the dot counts detected by the dot count detection unit 100 for each color of the print heads with reference to the tables 1-4.

The service execution unit 140 executes the spitting services for the print heads based on the spitting service levels determined by the service level determination unit 120 and outputs the execution result to the dot count initialization unit 160.

The dot count initialization unit 160 initializes the dot counts and outputs an initialization result to the next print check unit 180.

After executing all of the spitting services with respect to the wide array print head, the dot count initialization unit 160 initializes currently recorded dot counts in order to record new dot counts to be extracted as a next page is printed.

The next print check unit 180 checks an existence of a new page to be printed in response to an initialization result by the dot count initialization unit 160.

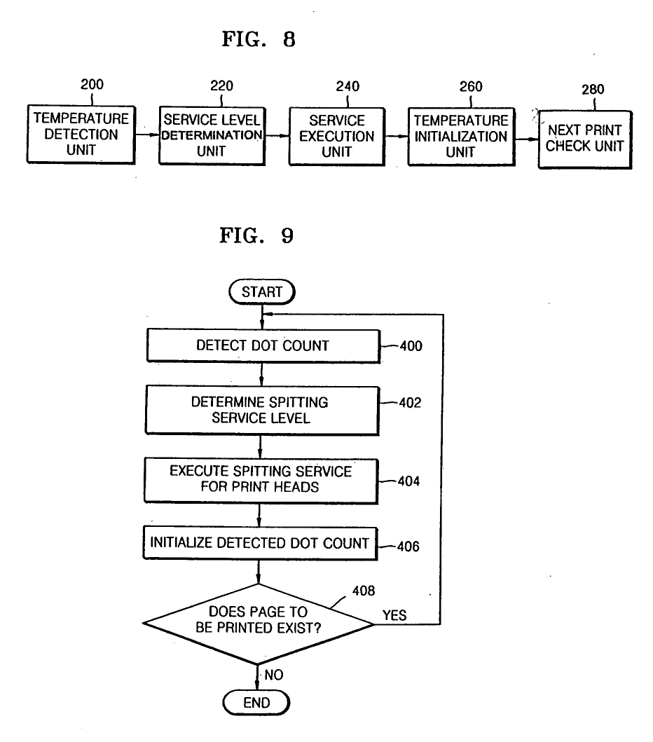

FIG. 8 is a block diagram illustrating a spitting service apparatus of a wide array print head according to an embodiment of the present general inventive concept. The spitting service apparatus includes a temperature detection unit 200, a service level determination unit 220, a service execution unit 240, a temperature initialization unit 260, and a next print check unit 280.

After a predetermined number of pages are printed, the temperature detection unit 200 detects the temperatures of print heads of the wide array print head and outputs a detection result (detected temperatures) to the service level determination unit 220.

Here, the predetermined number of pages may be one page. The spitting service of the wide array print head of the present general inventive concept is executed after one page of printing.

The temperature detection unit 200 detects the temperatures of the respective print heads provided in the wide array print head.

The service level determination unit 220 determines the spitting service levels corresponding to the detected temperatures and outputs the detection result (the determined spitting service levels) to the service execution unit 240.

The spitting service may be classified into several levels. The number of spitting is in inverse proportion to the temperature of the extracted ink.

In particular, the service level determination unit 220 determines the spitting service level using a table having information of the number of spitting which is in inverse proportion to the temperature.

The service execution unit 240 executes the spitting services for the print heads based on the spitting service levels determined by the service level determination unit 220 and outputs an execution result to the temperature initialization unit 260.

The temperature initialization unit 260 initializes the detected temperatures and outputs an initialization result to the next print check unit 280.

The next print check unit 280 checks an existence of a page to be printed in response to an initialization result by the temperature initialization unit 260.

FIG. 9 is a flowchart illustrating a spitting service method in a spitting service apparatus of a wide array print head according to an embodiment of the present general inventive concept.

After a page is printed, dot counts of a plurality of driving elements provided in the respective print heads are detected (operation 400). Each print head provided in the wide array print head may have the plurality of driving elements. The dot counts of ink extracted from the driving elements are detected. Referring to FIGS. 11 and 12, driving elements 610 and/or 610a may be arranged on a print head 6 corresponding to a plurality of nozzles 616 which may be in lines of groups of nozzles such as nozzle line 51 for example. The groups of nozzles may be arranged in lines corresponding to colors of ink (6C, 6M, 6Y, and 6K).

After the operation 400, the spitting service levels corresponding to the respective dot counts of the detected driving elements are determined (operation 402).

After the operation 402, spitting services on the respective printing heads are executed according to the assigned spitting service levels (operation 404).

After the operation 404, the detected dot counts are initialized (operation 406).

After the operation 406, existence of a page to be printed is checked (operation 408). If the page to be printed exists, the operations (402, 404, and 406) are performed.

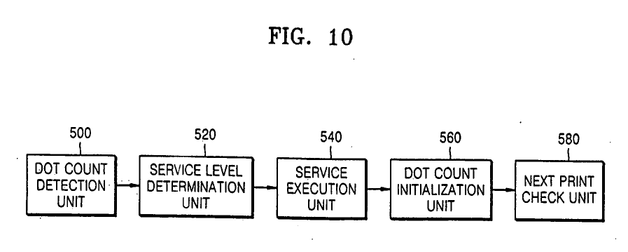

FIG. 10 is a block diagram illustrating a spitting service apparatus of a wide array print head according to an embodiment of the present general inventive concept. The spitting service apparatus includes a dot count detection unit 500, a service level determination unit 520, a service execution unit 540, a dot count initialization unit 560, and a next print check unit 580.

After a page is printed, the dot count detection unit 500 detects dot counts of the respective print heads and outputs the detection result to the service level determination unit 520. If each print head includes a plurality of print lines each having a plurality of nozzles, the dot counts are detected from the respective print lines each having the plurality of nozzles. The spitting service can be performed on the respective print lines according to the detected dot counts.

The service level determination unit 520 determines spitting service levels corresponding to the dot counts of the detected driving elements and outputs the detection result (determined spitting service levels) to the service execution unit 540.

The service execution unit 540 executes the spitting services for the print heads according to the spitting service levels determined by the service level determination unit 520 and outputs the execution result to the dot count initialization unit 560.

The dot count initialization unit 560 initializes the detected dot counts and outputs an initialization result to the next print check unit 580.

The next print check unit 580 checks the existence of a page to be printed in response to the initialization result by the dot count initialization unit 560.

In a method and apparatus to execute a spitting service on a wide array print head according to the present general inventive concept, spitting services for a plurality of print heads of the wide array print head can be classified into several levels for execution, so that the respective print heads can maintain the optimum condition and provide the best printing quality.

In addition, since the spitting service is executed on a corresponding level according to a dot count of an ink extracted for printing, unnecessary ink consumption can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A spitting service method of a wide array print head, comprising:
detecting dot counts of print heads after a predetermined page is printed;
determining spitting service levels corresponding to the respective detected dot counts; and
executing spitting services of the respective print heads according to corresponding ones of the spitting service levels.

2. The method of claim 1, wherein the predetermined page is one page.

3. The method of claim 1, wherein the detecting of the dot counts comprises detecting the dot counts of different colors of ink provided in the print heads.

4. The method of claim 1, wherein the determining of the spitting service levels comprises determining the spitting service levels by use of a table having information the number of the spitting which is in inverse proportion to the dot count.

5. The method of claim 1, further comprising:
initializing the detected dot counts; and
checking an existence of a next page to be printed, wherein if the next page to be printed exists, the detecting of the dot counts is performed.

6. A computer-readable medium having embodied thereon a computer program for executing a wide array print head spitting service method of:
detecting dot counts of print heads after a predetermined page is printed;
determining spitting service levels corresponding to the respective detected dot counts; and
executing spitting services of the respective print heads according to corresponding ones of the spitting service levels.

7. A spitting service method of a wide array print head, comprising:
detecting temperatures of print heads after a predetermined page is printed;
determining spitting service levels corresponding to the respective detected temperatures; and
executing spitting services on the respective print heads according to corresponding ones of the determined spitting service levels.

8. The method of claim 7, wherein the predetermined page is one page.

9. The method of claim 7, wherein the determining of the spitting service levels comprises determining the spitting service levels with use of a table having information on the number of spitting which is in inverse proportion to the temperatures.

10. The method of claim 7, further comprising:
checking an existence of a next page to be printed, wherein, if a page to be printed exists, the detecting of the temperatures is performed.

11. A computer-readable medium having embodied thereon a computer program for executing a wide array print head spitting service method of:
detecting temperatures of print heads after a predetermined page is printed;
determining spitting service levels corresponding to the respective detected temperatures; and
executing spitting services on the respective print heads according to corresponding ones of the determined spitting service levels.

12. A spitting service apparatus usable with a wide array print head, comprising:
a dot count detection unit which detects dot counts of print heads after a predetermined page is printed;
a service level determination unit which determines spitting service levels corresponding to the respective detected dot counts; and
a service execution unit which executes spitting services on the respective print heads according to corresponding ones of the spitting service levels.

13. The apparatus of claim 12, wherein the predetermined page is one page.

14. The apparatus of claim 12, wherein the dot count detection unit detects the dot counts of different colors of ink provided in the print heads.

15. The apparatus of claim 12, wherein the service level determination unit determines the spitting service levels with use of a table having information of the number of the spitting which is in inverse proportion to the dot count.

16. The apparatus of claim 12, further comprising:
a dot count initialization unit which initializes the detected dot counts; and
a next print check unit which checks an existence of a next page to be printed.

17. A spitting service apparatus usable with a wide array print head, comprising:
a temperature detection unit which detects temperatures of print heads after a predetermined page is printed;
a service level determination unit which determines spitting service levels corresponding to the respective detected temperatures; and
a service execution unit which executes spitting services on the respective print heads according to corresponding ones of the spitting service levels.

18. The apparatus of claim 17, wherein the predetermined page is one page.

19. The apparatus of claim 17, wherein the service level determination unit determines the spitting service levels with use of a table having information on the number of spitting which is in inverse proportion to the temperatures.

20. The apparatus of claim 17, further comprising:
a temperature initialization unit which initializes the detected temperatures; and
a next print check unit which checks an existence of a page to be printed.

21. A spitting service method of a wide array print head, comprising:
detecting dot counts of a plurality of driving elements provided in print heads after a predetermined page is printed;
determining spitting service levels corresponding to the detected dot counts;
executing spitting services for the print heads according to corresponding ones of the spitting service levels;
initializing the detected dot counts; and
checking an existence of a next page to be printed, wherein, if a page to be printed exists, the dot counts of the plurality of driving elements are detected.

22. A spitting service apparatus usable with a wide array print head, comprising:
a dot count detection unit which detects dot counts of a plurality of print heads after a page is printed;
a service level determination unit which determines spitting service levels corresponding to the detected dot counts;
a service execution unit which executes spitting services on the print heads according to corresponding ones of the spitting service levels;
a dot count initialization unit which initializes the detected dot counts; and
a next print check unit which checks an existence of a next page to be printed.

23. A spitting service apparatus usable with an array printhead, comprising:
a detection unit to detect information on ink consumption of respective print heads;
a determination unit to determine spitting service levels corresponding to the respective information; and
an execution unit to execute spitting services on the respective print heads according to corresponding ones of the spitting service levels.

24. The spitting service apparatus of claim 23, wherein the information on the ink consumption comprises at least one of dot counts and temperatures of the respective print heads.

25. The spitting service apparatus of claim 23, wherein each spitting service comprises spitting a number of times corresponding to each spitting service level.

26. The spitting service apparatus of claim 23, wherein:
the print heads comprise a first print head and a second print head;
the information comprises first information on the ink consumption of the first print head and second information on the ink consumption of the second print head;
the spitting service levels comprise first and second service levels according to the first and second information; and
the determination unit comprises a table containing a relationship between the spitting service levels and the respective information.

27. The spitting service apparatus of claim 26, wherein the table comprises a plurality of tables corresponding to color inks.

28. The spitting service apparatus of claim 26, wherein:
the spitting services comprise first and second spitting services according to the first and second spitting service levels; and
the execution unit executes the first spitting service on the first print head according to the first spitting service level and the second spitting service on the second print head according to the second spitting service level.

29. The spitting service apparatus of claim 28, wherein:
the first spitting service comprises spitting a first number of times; and
the second spitting service comprises spitting a second number of times.

30. The spitting service apparatus of claim 23, wherein each of the print heads comprises one or more nozzles to consume ink and the detection unit detects information on ink consumption of the one or more nozzles of each of the respective print heads.

31. The spitting service apparatus of claim 23, wherein the print heads are spaced apart from each other and arranged in a longitudinal direction of the array print head, and each print head comprises a plurality of nozzles arranged in the longitudinal direction to consume ink.

32. A spitting service method usable in an array print head, the method comprising:
detecting information on ink consumption of respective print heads;
determining spitting service levels corresponding to the respective information; and
executing spitting services for the respective print heads according to corresponding ones of the spitting service levels.

33. A computer-readable medium having embodied thereon a computer program for executing a wide array print head spitting service method of:
detecting information on ink consumption of respective print heads;
determining spitting service levels corresponding to the respective information; and
executing spitting services for the respective print heads according to corresponding ones of the spitting service levels.

34. A spitting service apparatus usable with an array print head, comprising:
detection unit to detect ink consumption information on a respective group of nozzles;
a determination unit to determine spitting service levels corresponding to the respective information; and
an execution unit to execute spitting services on the respective groups of nozzles according to corresponding ones of the spitting service levels.

35. An image forming apparatus comprising:
an array print head unit having a plurality of print heads arranged in a direction to form an image on a printing medium;
a spitting service device usable with the array print head unit including a detection unit to detect information on an ink consumption of respective print heads;
a determination unit to determine spitting service levels corresponding to the respective information; and
an execution unit to execute spitting services on the respective print heads according to corresponding ones of the spitting service levels.
